(19) United States
(12) Patent Application Publication
(10) Pub. No.: US 2014/0284310 A1
(43) Pub. Date: Sep. 25, 2014

(54) SWITCH FOR DIRECT CURRENT OPERATION HAVING AT LEAST ONE CIRCUIT BREAKER CHAMBER

(71) Applicant: EATON ELECTRICAL IP GMBH & CO. KG, Schoenefeld (DE)

(72) Inventors: Karsten Gerving, Bonn (DE); Volker Lang, Bonn (DE); Johannes Meissner, Bonn (DE); Ralf Thar, St. Augustin (DE)

(73) Assignee: EATON ELECTRICAL IP GMBH & CO. KG, Schoenefeld (DE)

(21) Appl. No.: 14/359,915

(22) PCT Filed: Nov. 26, 2012
(86) PCT No.: PCT/EP2012/073646

§ 371 Date: May 22, 2014

(30) Foreign Application Priority Data
Nov. 24, 2011 (EP) 11190517.0

(51) Int. Cl. H01H 9/44

(52) U.S. Cl. CPC H01H 9/443
USPC 218/26

(57) ABSTRACT

A switch for, in particular, direct current operation, having at least one circuit breaker chamber, each circuit breaker chamber having two contact pieces having respectively a first contact area, an electrically conductive bridge circuit which can be moved by means of a contact bridge and which has two contact regions for establishing an electrically conductive connection between the first and second contact regions and for separating at least one of the two contact regions from the respective first contact region, in addition to at least two magnets for generating a magnetic field.

### CROSS-REFERENCE TO PRIOR APPLICATIONS

This application is a U.S. National Stage application under 35 U.S.C. §371 of International Application No. PCT/EP2012/073646, filed on Nov. 26, 2012, and claims benefit to European Patent Application No. 11 190 517.0, filed on Nov. 24, 2011. The International Application was published in German on May 30, 2013, as WO 2013/076310 A1 under PCT Article 21(2).

### FIELD

The invention relates to a switch that is provided in particular for direct current service (DC), comprising at least one switching chamber.

### BACKGROUND

Electrical switches are components in a circuit which create or break an electrically conductive connection by means of internal, electrically conductive contacts. In the case of a current-carrying connection that is to be broken, current flows through the contacts until these are separated from each other. If an inductive circuit is to be broken by a switch, the current flow is not immediately reduced to zero, which can result in the formation of an electric arc between the contacts. The arc is a gas discharge in a non-conductive medium, for example air. In switches in alternating current service (AC), arcs are generally quenched at the zero-crossing point of the alternating current. Since such a zero-crossing point for the current is missing in switches with direct current service (DC), it is possible for stable electric arcs to be formed when the contacts are broken. Insofar as the circuit is operated with sufficient amperage and voltage, for example, with more than one amp and more than 50 volts, the electric arc is not quenched automatically. For this reason, in the case of such switching devices the quenching of the arc is accelerated by the use of a magnetic field that is polarized in such a way that it exerts a driving force on the arc in the direction of the quenching chamber. Permanent magnets are generally used to create a strong magnetic field. Unfortunately, the driving force of the magnetic field in the direction of the quenching chamber only occurs when the current flows in a particular direction. Installation errors caused by the polarisation of the switches are avoided in switches for both current directions that have a quenching behavior for arcs that is independent of the relevant polarisation. For example, such a switch is described in the brochure EP 2 061 053 A2.

The quenching chambers that serve to quench the arc are provided in order to reduce the arcing time (the duration of the arc burning) to as short as possible, because the arc generates a significant amount of heat, and it burns off the contacts and/or generates thermal load on the switching chamber in the switch and this reduces the service life of the switch. The installation space for switches with corresponding quenching chambers in particular for non-pole dependent switches is considerable. In the case of two-pole or multi-pole switches the arcs generate a correspondingly higher amount of heat than in the case of one-pole switches, which also makes larger switch cabinets with a greater installation space necessary.

### SUMMARY

An aspect of the invention provides a switching device, comprising a switching chamber, the switching chamber comprising: at least two first contact pieces, each first contact piece including a first contact area; a bridge contact piece, which is moveable and electrically conductive, and includes switch bridge including at least two second contact areas, the bridge contact piece being configured to provide an electrically conductive connection between the first and the second contact areas, and the bridge contact piece being configured to disconnect at least one of the two second contact areas from the respective first contact area; and at least two primary magnets configured to generate a magnetic field, wherein the switching device has a modular construction, wherein the switching device can be configured to include only one switching chamber for single-pole service, and wherein the switching device is scalable via an addition of at least a second switching chamber for multi-pole service.

### BRIEF DESCRIPTION OF THE DRAWINGS

The present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1, a perspective view of an embodiment of a switching device according to the invention;

FIG. 2, an exploded view drawing of the switching device according to FIG. 1; and

FIGS. 3a and 3b, two perspective views of a detail of the switching device according to FIG. 1.

### DETAILED DESCRIPTION

An aspect of the invention relates to a switch that is provided in particular for direct current service (DC), comprising at least one switching chamber, whereby each switching chamber has two contact pieces each of which has a first contact area, a movable, electrically conductive bridge contact piece with a switch bridge with two second contact areas for the production of an electrically conductive connection between the first and the second contact areas and for the disconnection of at least one of the two contact areas from the relevant first contact area, as well as at least two magnets to generate a magnetic field.

An aspect of the invention provides a switch with a fast and reliable quenching behavior for the arcs that are created, the installation space for which is adjusted to the volume of heat released, but without necessitating an increase in the part variety of the switch cabinets.

The switching device according to an aspect of the invention should be suitable for DC service in particular, have one or more switching chambers and preferably embody a double break and should be polarity independent. Every switching chamber must have, according to the invention, two contact pieces each of which has a first contact area and a movable, electrically conductive bridge contact piece with a switch bridge. Via the bridge contact piece an electrically conductive connection between the first and the second contact areas can be created, whereby a single break switch is only separable via one of the contact pairs from the first and the second contact area, whilst the other contact pair remains permanently connected via a stranded wire, for example. In the case of a double break switch both of the second contact areas are disconnected from the relevant first contact area. In order to create a magnetic field, each chamber has at least two magnets, in particular permanent magnets.

According to an aspect of the invention, a modular construction is provided for the switch, whereby the switch with only one switching chamber is provided for single-pole service and it is scalable for at least a second switching chamber for multi-pole service. Thus, by adding a switching chamber per pole the installation space for the switch is adjusted to the volume of warmth created by the arcs. The modular construction facilitates the use of advantageously standardized switching chamber components, in order to produce either single or multi-pole switches.

A preferred embodiment concerns the two-pole service of the switch, whereby two switching chambers are linked together in such a way that their relevant opening sides face each other. The switches that are equally preferred for two-pole service are electrically insulated from each other by means of a panel, whereby in the case of single-pole operations the panel serves as a cover for the switching chamber casing.

Preferably the two switching chambers present a joint switch bridge in two-pole service with which to move the bridge contact pieces. According to a preferred embodiment it is provided that each switching chamber shall be equipped with an additional magnet to influence the magnetic field on the moveable switch bridge. One advantage of this additional magnet is that the magnetic field in the first and the second contact areas is particularly influenced as the additional magnet is positioned in the immediate vicinity of the first and second contact areas via the movement of the switch bridge. In particular, the strength of the magnetic field in this area is significantly increased by the additional magnet, which enables an advantageously accelerated quenching of electric arcs. The additional magnet is preferably set up in a recess in the movable switch bridge at the height of the contact areas.

The magnetic field exerts a magnetic force on the electrical arc(s), so that at least one of the arcs, preferably independent of the direction of the current in the arc, is driven in the direction of one of the quenching chambers, whereby the contact pieces in the switching chambers are set up in such a way that the second contact areas are essentially vertical in alignment with the direction in which the arcs are moving.

The additional magnet together with the switch bridge is moveable in the area of the separable first and second contact areas and used to strengthen the magnetic field. it is to be understood by this that the additional magnet is moveable within the direct vicinity of the first and second contact areas, not that it lies somewhere between the first and second contact areas. The minimum of two magnets are thereby at least double so far from the first and second contact areas for example, as the additional magnet. The minimum of two magnets can, in particular, be fixed outside of the switching chamber and/or in the area of the switching chamber wall, or on the inside of the switching chamber wall, preferably in an insulating pocket. The magnets are preferably configured as at least two plate-shaped magnets, the surfaces whereof are arranged parallel to one another.

In accordance with a preferred embodiment it is provided that each switching chamber and contact pair shall have at least two pieces of quenching equipment to quench the electric arcs that could occur upon the disconnection of the first and second contact areas. It is particularly preferable that four pieces of quenching equipment should be provided for the polarity insensitive quenching of the electric arcs.

According to a further preferred embodiment it is provided that the first electric arc conductors should extend from the first contact areas and the second electric arc conductors should extend from the second contact areas in the direction of the quenching equipment, whereby the distance of the first electric arc conductors from the second electric arc conductors in the direction of the quenching equipment is increased in a particularly preferred manner. In addition it is preferred that each bridge contact piece should extend diagonally, in particular in a somewhat right-angled direction to one of the directions of the range of the contact pieces. Diagonal to a direction is to be understood in the sense of not parallel to the direction.

In addition, it is preferred that the contact pieces for multi-pole service are configured in such a way that the connections for the switching device correspond to a multi-pole AC switching device with regard to their position and/or mounting position. Thus incorrect wiring due to the unusual positioning of the connections for DC switching devices vis-à-vis the considerably more frequently used AC switching devices is advantageously avoided.

The invention will be described in further detail below based on one embodiment, with reference to the drawings. The designs are exemplary and do not restrict the general concept of the invention

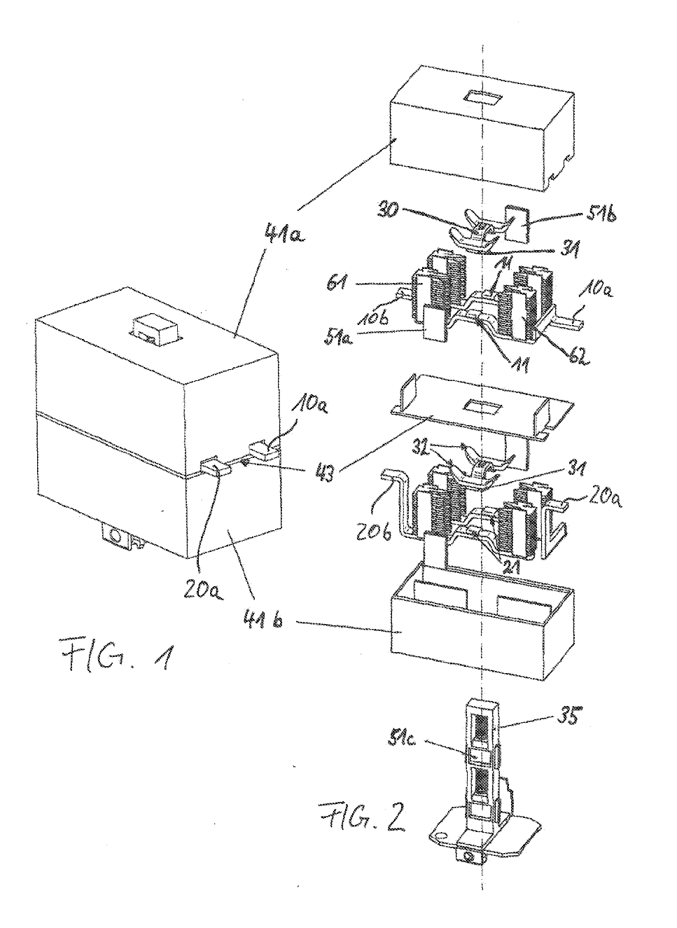

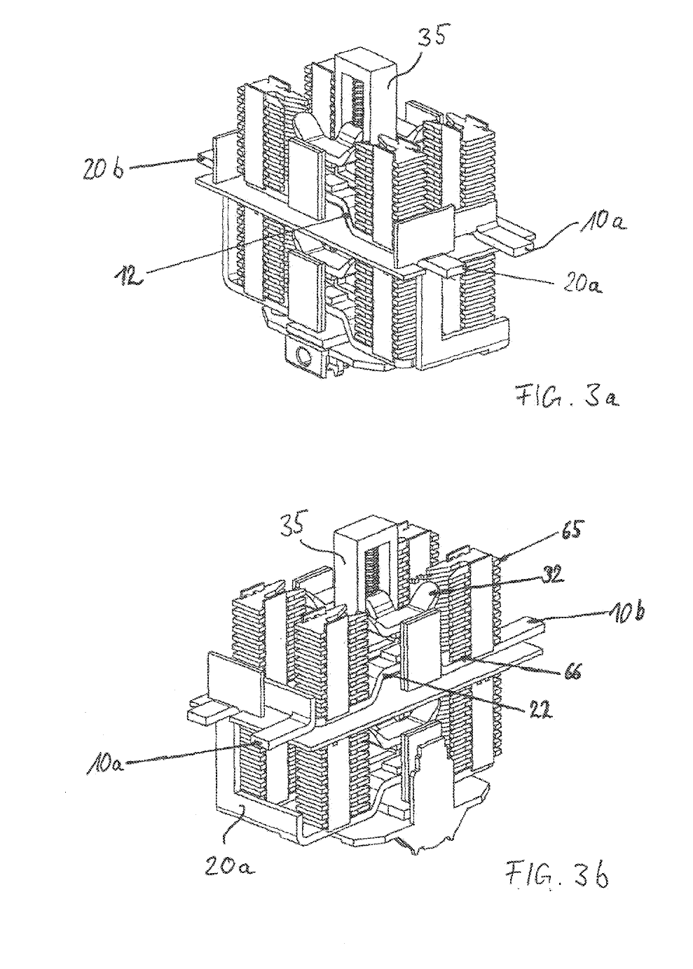

The embodiment example according to FIG. 1 shows a switching device according to the invention, in particular here a multi-pole compact switching device that is independent of the direction of the current, that according to the invention shows an effective quenching behavior via the shortest possible time for an electric arc during switching operations. The connections for the main circuits or contact pieces 10a, 20a are always located opposite at the same level relative to the installation depth of the switching device, as with standard AC protection. The contact pieces 10b, 20b that are located opposite are located behind the switching device in FIG. 1 and therefore can only be identified in the other FIGS. 2, 3a and 3b.

In order to realize a compact switching topology which has a similarly small installation length and depth as a pure AC switching device for comparable currents when installed in a switch cabinet, the switching device is embodied in the shape of two switching chambers mounted on top of each other 41a, 41b preferably with identical construction, which in particular facilitates a single-pole switch with only one switching chamber 41b to be realized or to be scaled up to a two-pole switch by adding a further switching chamber 41a in a modular fashion.

The switching topologies for each pole are located in two separate, identical switching chambers 41a, 41b, which are mounted on top of each other. The switching chambers 41a, 41b are mounted with their opening sides facing each other. In order to ensure sufficient electrical insulation both switching chambers 41a, 41b are sealed off from each other by a partition 43 made of insulating material. In this way a cost-effective solution with compact installation parameters is realized. If the partition 43 is embodied as a lid, the switching device according to the invention can also be constructed on a modular basis, either single-pole with just one switching chamber 41b or double-pole with both switching chambers 41a, 41b according to choice.

The switching device according to the invention is further described with reference to the exploded view drawing in FIG. 2. The first pole and the first switching chamber 41a have two contact pieces 10a, 10b each of which has a first contact area 11 and a movable, electrically conductive bridge contact piece 30 with a switch bridge 35 with two second contact areas 31 to create an electrically conductive connection between the first and the second contact areas 11, 31 and to separate the second contact areas 31 from the first contact area 11. The second switching chamber 41b has two contact pieces 20a, 20b each of which has a first contact area 21. The bridge contact piece 30 with the second contact area 31 is identical to the first switching chamber 41a and identified accordingly. The moveable bridge contact pieces 30 for both poles are hereby mounted on top of each other on the shared switch bridge 35, whereby a synchronized switching procedure is realized for each pole.

The first and second contact areas 11, 31 and 21, 31 are also referred to in the following as fixed contact areas 11, 21 and moveable contact areas 31, which form the contact pairs. The contact pairs each have two pieces of preferably identical quenching equipment 61, 62. The pieces of quenching equipment are preferably embodied as so-called deionising chambers, that consist of a stack of sheets 66 that are electrically insulated from each other, each of which has an air gap between itself and its neighbor. Alternatively, the pieces of quenching equipment can also comprise a simple niche arrangement without a package of quenching sheets, with walls of insulation material, preferably of thermosetting plastic or ceramic, whereby the individual niches are adequately sealed off from each other spatially and an exterior wall is equipped with appropriately dimensioned outlets that serve to relieve the rise in pressure caused by the electric arcs created in the switching operations.

The bridge contact pieces 30 with the moveable second contact areas 31 are switched on at the height of the centre of the quenching equipment 61, 62. In the direction of the quenching equipment 61, 62 they are lengthened to form secondary curved electric arc conductors or electric arc conductor chutes 32, whereby upon switching off the ends point roughly in the direction of the outer edges 65 of the quenching equipment. The moveable contact areas 31 are always at the interface between the bridge contact piece 30, which is turned at an almost 90 degree angle towards the connecting axis of the two opposite pieces of quenching equipment 61, 62 and the right-angled electric arc conductor chute 32 emanating from there.

In FIGS. 3a and 3b two perspective views of the switching device according to FIG. 1 are illustrated, however, without the chamber walls for the switching walls 41a, 41b. The perspective in FIG. 3a corresponds with that of FIG. 1, whilst FIG. 3b shows a perspective that has been turned by 90 degrees. In contrast to the moveable bridge contact pieces 30 the contact pieces 10a, 10b, 20a, 20b with the fixed contact areas 11, 21 for both the poles of the switching device are embodied differently and are described in the following in relation to FIGS. 3a and 3b. In the case of the upper switching device 41a for one pole, both the contact piece carriers 10a, 10b are mounted on top of each other parallel to the longer chamber wall at the lower end of the switching chamber 41a, whereby the one contact piece 10a is bent directly behind the inner chamber wall by 90 degrees in a direction parallel to the short side of the switching chamber 41a and shortly before it reaches the side wall of the chamber it is once again bent at an angle of 90 degrees parallel to the bottom of the chamber and the partition 43. In this way a parallel offset of both the contact pieces 10a, 10b is achieved to the effect that both the current paths running parallel to each other are directed towards the longer side of the chamber. Therefore starting from the switching chamber wall they initially run under the quenching equipment 61, 62. Outside of the quenching equipment 61, 62 they are bent diagonally upwards, so that both the fixed contacts 11 are aligned at the height of the middle of the quenching equipment 61, 62. Together with the moveable bridge contact pieces 30 this creates an electric arc conductor configuration with the second electric arc conductor 32 and the first electric arc conductor 12, whereby the distance between them increases in the direction of the quenching equipment 61, 62. Along the length of the electric arc conductor 12, 32 the electric arc is expanded with the help of a magnetic blowout field until it achieves the same length as the height of the complete quenching equipment 61 and 62.

In the lower switching chamber 41b of the second pole the contact pieces 20a, 20b are illustrated in a similar fashion, however with the difference, that both the contact pieces 20a, 20b directly following entry in the switching chamber 41b are first bent at a right angle in a direction parallel to the short side of the switching chamber 41b, so that they run in the direction of the chamber floor. The one contact piece 20a is then bent once again by 90 degrees in a direction parallel to the short chamber wall, then bent again at right angles before the chamber wall in a direction parallel to the chamber floor. In this way the contact piece 20a is led along the chamber floor parallel to the longer side of the chamber walls in analogy to the switching chamber 41a. The second contact piece 20b is bent once again at right angles in the area of the chamber floor in such a way that it is displaced and runs parallel to the first contact piece along the chamber floor. In analogy to switching chamber 41a for the first pole both the contact pieces 20a, 20b first run under the quenching equipment 61, 62 starting from the switching chamber wall. Once outside the equipment they are once again bent vertically upwards, so that both the fixed contact areas 21 are aligned at the height of the centre of the quenching equipment 61, 62.

Via the embodiment described a switching device with optimized electric arc conductor behavior is realized in such a way that the resulting electrical switching arcs are directed in a targeted manner towards one of the pieces of quenching equipment 61, 62 within a very short space of time and with the help of a magnetic blowout field. Thanks to the special embodiment of the contact pieces 10a, 10b, 20a, 20b, it is also achieved that the connections of the main circuits with regard to positioning and installation depth are aligned in the same way as with a multi-pole AC switching device.

According to the invention and within the embodiment illustrated in both of the switching chambers 41a, 41b an arrangement of at least two permanent magnets 51a, 51b and an additional magnet 51c is prescribed. The two magnets 51a, 51b can for example be positioned outside the switching chambers 41a, 41b, whilst the additional magnet 51c is positioned on the moveable switch bridge 35 in order to influence the magnetic field, preferably at the height of the moveable contact area 31. In order to realize this position the bridge contact pieces 30 are bent trapezoidally on both sides. The result is thus the realisation of a cost-effective arrangement of magnets with a comparably high magnetic field strength in the area of the switch contacts.

The permanent magnetic arrangement means that the partial arcs that are formed once the contacts are opened due to the effective Lorentz force are always forced in the direction of the total of four pieces of quenching equipment 61, 62 where they are quenched, irrespective of the direction of the current. The arrangement of the additional magnets 51c directly in the area of the switch contacts facilitates the creation of a homogeneous magnetic field with a high magnetic field strength, which, due to the blowout effect facilitates the quick movement of the electric arc in the direction of the relevant piece of quenching equipment 61, 62 and thus results in a relatively short retention time for the arc between the contact areas 11, 31 and 21, 31, whereby the burn-up of the contacts is advantageously reduced and the service life of the switching device is increased.

The permanent magnets 51a, 5 lb and 51c are preferably made of ferritic material and material with rare earth metals, for example Nd—Fe—B or Sa—Co and from materials that allow the formation of plastic bonded molding. The switching chamber casings are preferably made of ceramic or thermoplastic and divided into four bays by separate bulkhead walls that always have outlet openings on the outside.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B, and C” should be interpreted as one or more of a group of elements consisting of A, B, and C, and should not be interpreted as requiring at least one of each of the listed elements A, B, and C, regardless of whether A, B, and C are related as categories or otherwise. Moreover, the recitation of “A, B, and/or C” or “at least one of A, B, or C” should be interpreted as including any singular entity from the listed elements, e.g., A, any subset from the listed elements, e.g., A and B, or the entire list of elements A, B, and C.

### LIST OF REFERENCE SYMBOLS

10a, 10b, 20a, 20b Contact pieces

11, 21 First, fixed contact areas

12, 22 First, fixed electric arc conductors

30 Bridge contact piece

31 Second, moveable contact area

32 Second, moveable electric arc conductors

35 Moveable switch bridge

41a, 41b Switching chambers

43 Partition

51a, 51b Magnets

51c Additional magnet

61, 62 Quenching equipment

65 Outer edge of the quenching equipment

66 Sheet

1. A switching device, comprising a switching chamber, the switching chamber comprising:
at least two first contact pieces, each first contact piece including a first contact area;
a bridge contact piece, which is moveable and electrically conductive, and includes a switch bridge including at least two second contact areas, the bridge contact piece being configured to provide an electrically conductive connection between the first and the second contact areas, and the bridge contact piece being configured to disconnect at least one of the two second contact areas from the respective first contact area; and
at least two primary magnets configured to generate a magnetic field, wherein the switching device has a modular construction,
wherein the switching device can be configured to include only one switching chamber for single-pole service, and
wherein the switching device is scalable via an addition of at least a second switching chamber for multi-pole service.

2. The device of claim 1, comprising:
two switching chambers for two pole service, each switching chamber including a side including an opening,
wherein the two switching chambers linked together in such a way that the respective sides including openings face each other.

3. The device of claim 1, wherein, for two-pole service, the switching chambers are electrically insulated from each other by a panel, and
wherein for single-pole service, the panel is configured as a cover for a casing of the switching.

4. The device of claim 1, comprising:
two switch chambers,
wherein the two switching chambers include a joint switch bridge in two-pole service, and
wherein the joint switch bridge is configured to move bridge contact pieces.

5. The device of claim 4, further comprising, for every switching chamber:
an additional magnet,
wherein the additional magnet is configured to influence a magnetic field in the switch bridge,
wherein the switch bridge is moveable.

6. The device of claim 5, wherein the additional magnet, together with the switch bridge, is moveable in an area of the first and second contact areas in order to strengthen the magnetic field.

7. The device of claim 5, wherein the additional magnet is attached in a recess in the switch bridge at a height of the second contact areas.

8. The device of claim 1, wherein the primary magnets are configured as at least two plate magnets whose areas are placed parallel to each other.

9. The device of claim 1, comprising:
only one switching chamber; and
at least two pieces of quenching equipment configured to quench electric arcs that can occur upon disconnecting the first and second contact areas.

10. The device of claim 1, comprising:
only one switching chamber; and
four pieces of quenching equipment configured for polarity insensitive quenching of electric arcs that can occur upon disconnecting the first and second contact areas.

11. The device of claim 5, further comprising:
first electric arc conductors;
second electric arc conductors; and
quenching equipment,
wherein the first electric arc conductors extend from the first contact areas in a direction of the quenching equipment, and
wherein the second electric arc conductors extend from the second contact areas in a direction of the quenching equipment.

12. The device of claim 11, wherein a distance between the first electric arc conductors and the second electric arc conductors increases in a direction of the quenching equipment.

13. The device of claim 1, wherein the bridge contact piece extends in a diagonal direction to one effective direction of the contact pieces.

14. The device of claim 1, wherein the contact pieces are configured for multi-pole service,
the contact pieces are configured in such a way that connections for the switching device correspond to a multi-pole AC switching device with regard position, mounting position, position and mounting position of the connections.
